(19) United States
(12) Patent Application Publication
(10) Pub. No.: US 2002/0191783 A1
(43) Pub. Date: Dec. 19, 2002

(54) METHOD AND APPARATUS FOR CREATING A MESSAGE DIGEST USING A MULTIPLE ROUND, ONE-WAY HASH ALGORITHM

(76) Inventor: Richard J. Takahashi, Phoenix, AZ (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/880,700

(22) Filed: Jun. 13, 2001

(51) Int. Cl. H04L 9/00

(52) U.S. Cl. 380/28

(57) ABSTRACT

A one-way hash algorithm is implemented in hardware and/or software. The hash algorithm creates a message digest from an input message. During one iteration of the hash algorithm, two or more “rounds” are performed, where a “round” is a calculation that operates on one word of a sequence of input words derived from the message, and each successive round operates on the next word in the sequence. The first round performed during each iteration includes at least one carry save adder (212, FIG. 2) (CSA) and a full adder (224, FIG. 2). The second round also includes at least one CSA (226, FIG. 2) and a full adder (236, FIG. 2). In one embodiment, the message digest computed by the hash algorithm is identical to a message digest computed using SHA-1, when given the same input message.

### TECHNICAL FIELD OF THE INVENTION

The present invention relates generally to methods and apparatus for computing condensed representations of messages or data files, and more particularly to methods and apparatus for computing message digests using a one-way hash algorithm.

### BACKGROUND OF THE INVENTION

Hash functions have been widely used in modern cryptography to produce compressed data, message digests, fingerprints, and checksums, among other things. A hash function is a mathematical function that takes a variable-length input string, and converts it to a fixed-length output string. The output string is called a hash value, which typically is smaller than the input string. A “one-way” hash function is a hash function that works in one direction, meaning that it is easy to compute a hash value from an input string, but it is difficult to generate a second input string that hashes to the same value. Bruce Schneier, Applied Cryptography, at 429-59 (1996) includes a detailed discussion of various one-way hash algorithms.

A commonly used, one-way hash algorithm is the “Secure Hash Algorithm,” or “SHA-1,” which was developed by the National Institute of Standards and Technology (NIST) and the National Security Agency (NSA). SHA-1 is described in detail in the Federal Information Processing Standards Publication 180-1 (May 11, 1993) (FIPS PUB 180-1), issued by NIST.

The federal government requires SHA-1 to be used with their standardized “Digital Signature Algorithm” (DSA), which computes a signature for the message from a message digest. In addition, the federal government requires SHA-1 to be used whenever a secure hash algorithm is required for a federal application, and encourages its use by private and commercial organizations. Accordingly, the use of SHA-1 has become extremely common for applications that need a one-way hash algorithm.

When an input message of any length <2⁶⁴ bits is input into SHA-1, the algorithm produces a 160-bit output called a “message digest.” SHA-1 sequentially processes message blocks of 512 bits when computing a message digest. If a message is not a multiple of 512 bits, then SHA-1 first pads the message to make the message a multiple of 512 bits. The padded message is then processed by SHA-1 as n 512-bit blocks, M₁, . . . , Mₙ, where each block is composed of sixteen 32-bit words, L₀, L₁, . . . , L₁₅.

The message digest computation uses two buffers, each consisting of five 32-bit registers, and a sequence of eighty 32-bit words. The registers of the first 5-word buffer are labeled A, B, C, D, and E, and the registers of the second 5-word buffer are labeled, H₀, H₁, H₂, H₃, H₄. The words of the 80-word sequence derived from the sixteen 32-bit words in the message block, and are labeled W₀, W₁, . . . , W₇₉. A single word register, TEMP, is also employed.

One “round,” t, is performed during each iteration of SHA-1, where a round is defined as a calculation that operates on one word, Wₜ, of the 80-word sequence, referred to as the “input sequence.” Accordingly, the processing of each block involves eighty iterations. Because each iteration takes one clock cycle, the processing of each block uses eighty clock cycles.

During the eighty iterations, SHA-1 uses a sequence of eighty logical functions, f₀, f₁, . . . , f₇₉. Each function, fₜ, 0<=t<=79, operates on three 32-bit words, and produces a 32-bit word as output. SHA-1 also uses a sequence of constant words, K₀, . . . , K₇₉, during the eighty iterations.

To generate the message digest, first the H₀, H₁, H₂, H₃, H₄ registers are initialized to a predetermined set of initialization values. The creation of the message digest then involves the following operations, where each of the blocks, M₁, M₂, . . . , Mₙ are processed in order:

1) Divide Mₓ into sixteen 32-bit words, L₀, L₁, . . . , L₁₅, where L₀ is the leftmost word, and Mₓ is the next message block to be processed.

2) Let register A=H₀, B=H₁, C=H₂, D=H₃, and E=H₄

3) For t=0 to 15, let Wₜ=Lₜ; and

For t=16 to 79, let Wₜ=S¹ (Wₜ₋₃ XOR Wₜ₋₈ XOR Wₜ₋₁₄ XOR Wₜ₋₁₆), where S^{X} indicates a left circular shift by X bits.

4) For t=0 to 79,

TEMP=S⁵(A)+fₜ(B,C,D)+E+Wₜ+Kₜ;

A=TEMP; B=A; C=S³⁰(B); D=C; E=D

5) Let H₀=H₀+A; H₁=H+B; H₂=H₂+C; H₃=H₃+D, H₄=H₄+E Repeat steps 1-5 for the next block.

After processing the last block, Mₙ, the message digest is the 160-bit string represented by the five words H₀, H₁, H₂, H₃, H₄.

In many cases, the SHA-1 algorithm is performed within an application specific integrated circuit (ASIC), where the operations are performed using hardware-implemented logic gates. FIG. 1 illustrates a simplified, logical block diagram of one iteration through the SHA-1 algorithm, in accordance with the prior art. Specifically, FIG. 1 illustrates one iteration of step 4, above. Registers A, B, C, D, and E are represented by blocks 102, 104, 106, 108, 110, and registers H₀, H₁, H₂, H₃, H₄ are represented by blocks 126, 128, 130, 132, 134.

During one iteration of step 4, a non-linear function 112 (NLF), fₜ, is applied to the contents of registers B 104, C 106, and D 108. The result is added, by a first full adder 114, to the contents of register E 110. In addition, a first shifter 122 circularly left shifts the contents of register A 102 by 5 bits, and a second full adder 116 adds that result the output of the first full adder 114. A third and fourth full adder 118, 120 add Wₜ and Kₜ, respectively, to the output of the second full adder 116.

The output of the fourth full adder 120 is then added to the value stored in register H₀ 126. In addition, the contents of register A 102 is added to the value stored in register H₁ 128. A second shifter 124 circularly left shifts the contents of register B 104 by 30 bits, and that result is added to the value stored in register H₂ 130. Finally, the contents of register C 106 are added to the value stored in register H₃ 132, and the contents of register D 108 are added to the value stored in register H₄ 134.

During one iteration, the critical path includes NLF 112, fₜ, and four full adders 114, 116, 118, 120. Each full adder 114, 116, 118, 120 is a relatively complex portion of logic. Accordingly, since the processing of each block involves eighty iterations, the logic depth and the amount of time to process a full message are fairly substantial.

As the desire to compress data faster increases, communication systems increasingly place more stringent demands on the computation speed of cryptographic algorithms. Accordingly, what are needed are a one-way hash algorithm and apparatus, which produce the same output as SHA-1 using fewer clock cycles. Further, what are needed are a SHA-1 compatible hash algorithm and apparatus, which have less logic depth than the standard SHA-1 implementation.

### BRIEF DESCRIPTION OF THE DRAWING

FIG. 1 illustrates a simplified, logical block diagram of one iteration through the SHA-1 algorithm, in accordance with the prior art;

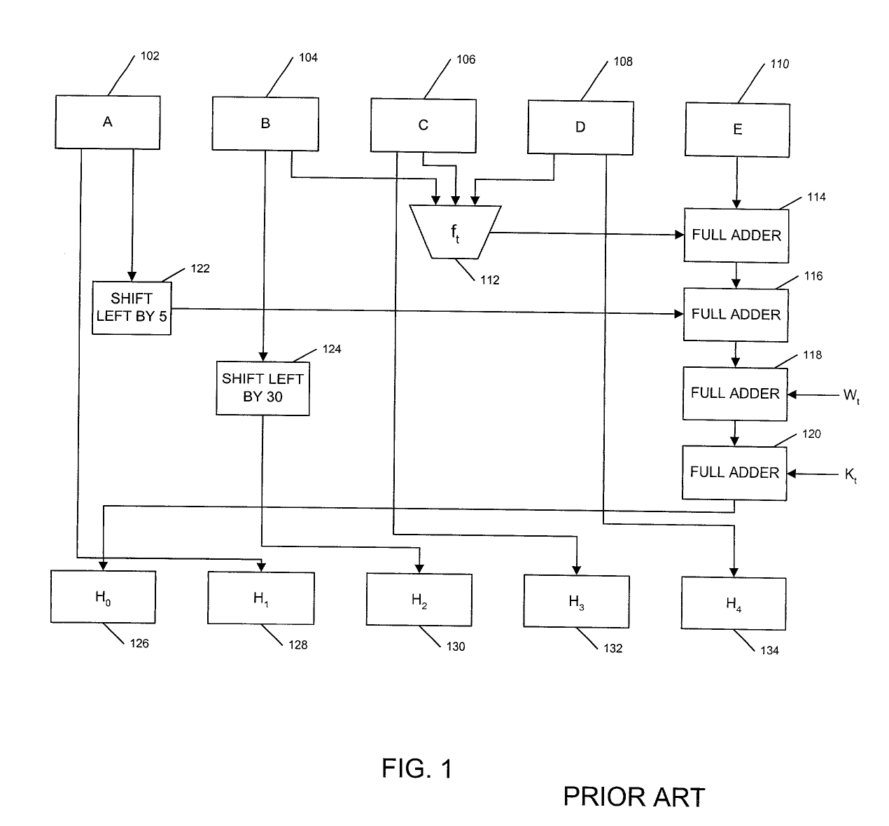

FIG. 2 illustrates a simplified, logical block diagram of one iteration through a one-way hash algorithm, in accordance with one embodiment of the present invention;

FIG. 3 illustrates a flowchart of a method for creating a message digest, in accordance with one embodiment of the present invention; and

FIG. 4 illustrates an electronic device in which the embodiments of the invention may be practiced, in accordance with one embodiment of the present invention.

### DETAILED DESCRIPTION OF THE INVENTION

Various embodiments of the present invention provide a one-way has algorithm and apparatus, which produce the identical message digest as SHA-1, given the same input message, but using fewer clock cycles and fewer iterations. Further, the various embodiments provide a SHA-1 compatible hash algorithm and apparatus, which have less logic depth that the standard SHA-1 implementation.

In various embodiments, these advantages are accomplished by computing multiple rounds, t, during one iteration of the algorithm. In addition, in various embodiments, each round uses fewer full adders than the SHA-1 implementation, thus reducing the logic depth of each round. For ease of description, the hash algorithm of the various embodiments is referred to herein simply as the “algorithm.”

Similar to SHA-1, when an input message of any length <2⁶⁴ bits is input into the algorithm of one of the various embodiments, the algorithm produces a 160-bit output, referred to herein as a message digest. In alternate embodiments, longer messages could be processed by the algorithm, as well. Although the term “message digest” has been used to indicate the output result of the algorithm, such terminology is not meant to limit the various embodiments to specific applications.

In one embodiment, the method of the present invention sequentially processes blocks of 512 bits when computing a message digest. If a message is not a multiple of 512 bits, then the algorithm first pads the message to make the message a multiple of 512 bits. The padded message is then processed by the algorithm as n 512-bit blocks, M₁, . . . , Mₙ, where each block is composed of sixteen 32-bit words, L₀, L₁, . . . , L₁₅.

In one embodiment, the message digest computation uses two buffers, each consisting of five 32-bit word registers, and a sequence of eighty 32-bit words, referred to as the “input sequence.” The registers of the first 5-word buffer are labeled A, B, C, D, and E. The registers of the second 5-word buffer are labeled, H₀, H₁, H₂, H₃, H₄. The words of the 80-word input sequence are derived from the sixteen 32-bit words in the message block, and are labeled W₀, W₁, . . . , W₇₉. In one embodiment, two single word registers, TEMP1 and TEMP2, are also employed. In other embodiments, more or fewer temporary registers could be used.

The algorithm of the various embodiments uses a sequence of eighty non-linear functions (NLF), f₀, f₁, . . . , f₇₉. Each function, fₜ, 0<=t<=79, operates on three 32-bit words, and produces a 32-bit word as output. These functions are the same as the functions used in SHA-1. fₜ(X, Y, Z) is defined as follows:

fₜ(X,Y,Z)=(X AND Y) OR ((NOT X) AND Z)(0<=t<=19)

fₜ(X,Y,Z)=X XOR Y XOR Z(20<=t<=39)

fₜ(X,Y,Z)=(X AND Y) OR (X AND Z) OR (Y AND Z)(40<=t<=59)

fₜ(X,Y,Z)=X XOR Y XOR Z(60<=t<=79).

The algorithm of the various embodiments also uses a sequence of constant words, K₀, . . . , K₇₉. These constants are the same as the constants used in SHA-1. In hex, these are given by:

Kₜ=5A827999(0<=t<=19)

Kₜ=6ED9EBA1(20<=t<=39)

Kₜ=8F1BBCDC(40<=t<=59)

Kₜ=CA62C1D6(60<=t<=79)

In one embodiment, two rounds, t, are performed during each iteration, i, of the algorithm, where t is a function of i. Accordingly, the processing of each message block involves forty iterations. Because each iteration takes one clock cycle, the processing of each block uses forty clock cycles. This is one distinction between the method of the various embodiments and the prior art SHA-1, which only performs one round during each iteration of its algorithm, and which uses eighty clock cycles. In other embodiments, as will be described in more detail later, more than two rounds, t, could be performed during each iteration, thus further reducing the number of iterations and clock cycles necessary to process each block.

To generate the message digest, first the H₀, H₁, H₂, H₃, H₄ registers are initialized. The creation of the message digest then involves the following operations, where each of the blocks, M₁, M₂, . . . , Mₙ are processed in order:

1) Divide Mₓ into sixteen 32-bit words, L₀, L₁, . . . , L₁₅, where L₀ is the leftmost word, and Mₓ is the next message block to be processed.

2) Let A=H₀, B=H, C=H₂, D=H₃, and E=H₄

3) For t=0 to 15, let Wₜ=Lₜ; and

For t=16 to 79, let Wₜ=S¹(Wₜ₋₃ XOR Wₜ₋₈ XOR Wₜ₋₁₄ XOR Wₜ₋₁₆),

where S^{X} indicates a left circular shift by X bits.

4) For i=0 to 39,

TEMP1=E+W₂ᵢ+K₂ᵢ+f₂ᵢ(B,C,D)+S⁵(A);

TEMP2=D+W₂ᵢ₊₁+K₂ᵢ₊₁+f₂ᵢ₊₁(A, S³⁰(B), C)+S⁵(TEMP1);

A=TEMP2; B=TEMP1; C=S³⁰(A); D=S³⁰(B); E=C;

5) Let H₀=H₀+A; H₁=H+B; H₂=H₂+C; H₃=H₃+D, H₄=H₄+E Repeat steps 1-5 for the next block.

After processing the last block, Mₙ, the message digest is the 160-bit string represented by the five words H₀, H₁, H₂, H₃, H₄. In one embodiment, this message digest is completely compatible with a message digest produced by SHA-1, which used the same input message data.

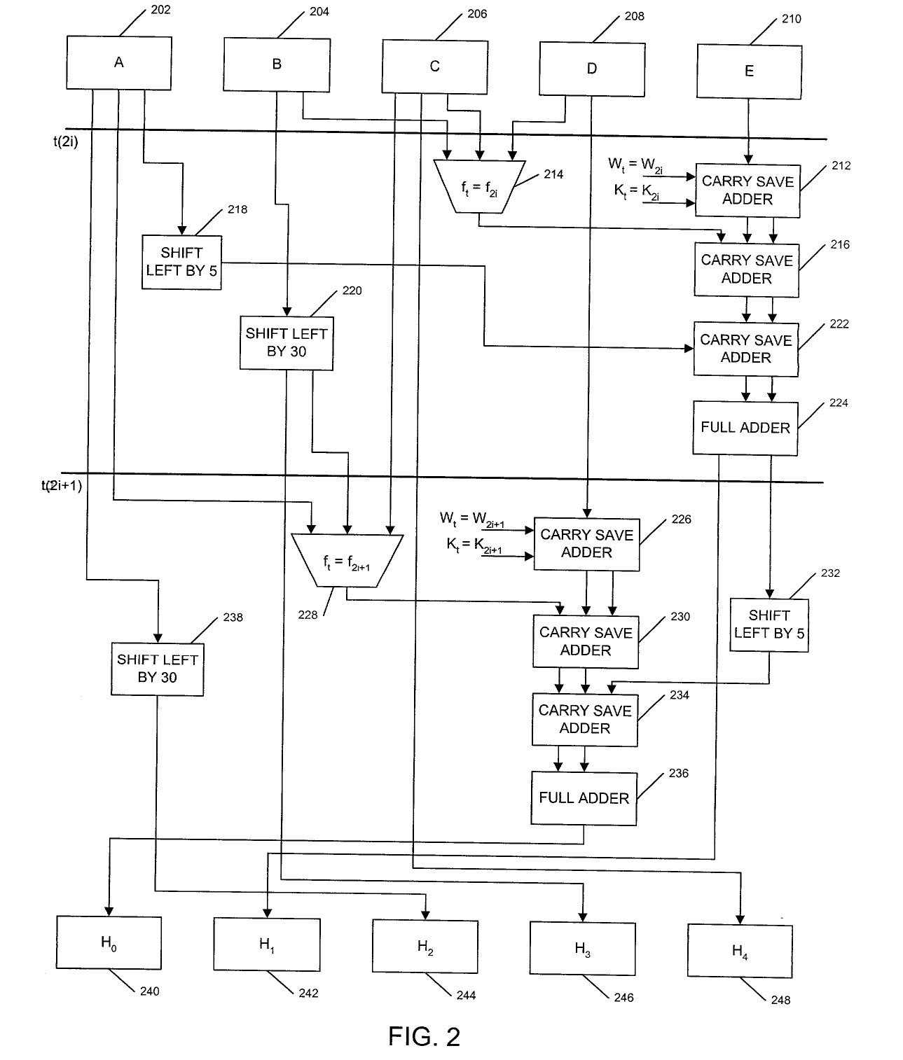

FIG. 2 illustrates a simplified, logical block diagram of one iteration through a hash algorithm, in accordance with one embodiment of the present invention. Specifically, FIG. 2 illustrates one iteration of step 4, above. Registers A, B, C, D, and E are represented by blocks 202, 204, 206, 208, 210, and registers H₀, H₁, H₂, H₃, H₄ are represented by blocks 240, 242, 244, 246, 248.

During one iteration of step 4, a first carry save adder 212 (CSA) is used to add the contents of register E 210 to Wₜ and Kₜ. In one embodiment, Wₜ=W₂ᵢ and Kₜ=K₂ᵢ, where i represents the number of the iteration that is being performed. Accordingly, during the first iteration of the algorithm, where i=0, the appropriate Wₜ to use is W₀, the first word of the 80-word input sequence. The appropriate Kₜ to use is K₀, or Kₜ=5A827999.

In addition, a first non-linear function 214 (NLF), fₜ, is applied to the contents of registers B 204, C 206, and D 208. In one embodiment, fₜ=f₂ᵢ. Accordingly, during the first iteration of the algorithm, where i=0, the appropriate NLF to use is f₀, or fₜ(X, Y, Z)=(X AND Y) OR ((NOT X) AND Z), where X=B, Y=C, and Z=D. A second CSA 216 then adds the output of NFL 214 to the output of the first CSA 212.

In addition, a first shifter 218 circularly shifts the contents of register A 202 by 5 bits, and a third CSA 222 adds that result to the output of the second CSA 216. A first full adder 224 is then used to incorporate the carry, which was propagated through CSAs 212, 216, and 222, into the sum.

In one embodiment, the output of first full adder 224 corresponds to TEMP1, the temporary register value described in conjunction with step 4 of the method described above. This result also represents the completion of a first round, t(2i), of the algorithm.

As the above description indicates, the first round uses at least one carry save adder and one full adder, in one embodiment. In simplified terms, the first round involves adding a word, W₂ᵢ, of the 80-word input sequence to modified and unmodified versions of at least some of the registers A, B, C, D, and E. When the first round is implemented in hardware (e.g., in an ASIC), the hardware includes a first logic block, and the first round is performed during a pass through the first logic block.

The second round, t(2i+1), is then performed as follows. A fourth CSA 226 adds the contents of register D 208 to Wₜ and Kₜ, where Wₜ=W₂ᵢ₊₁ and Kₜ=K₂ᵢ₊₁. Accordingly, during the first iteration of the algorithm, where i=0, the appropriate Wₜ to use is W₁, the second word of the 80-word input sequence. The appropriate Kₜ to use is K₁, or Kₜ=5A827999.

In addition, a second non-linear function 228 (NLF), fₜ, is applied to the contents of register A 202, C 206, and B 204, after register B has been circularly left shifted by 30 bits by a second shifter 220. In one embodiment, fₜ=f₂ᵢ₊₁. Accordingly, during the first iteration of the algorithm, where i=0, the appropriate NLF to use is f₁, or fₜ(X, Y, Z)=(X AND Y) OR ((NOT X) AND Z).

A fifth CSA 230 adds the output of the fourth CSA 226 to the output of NLF 228. A third shifter 232 circularly left shifts the output of first full adder 224 by 5 bits, and a sixth CSA 234 adds that result to the output of the fifth CSA 230. A second full adder 236 is then used to incorporate the carry, which was propagated through CSAs 226, 230, and 234, into the sum. In one embodiment, the output of second full adder 236 corresponds to TEMP2, the temporary register value described in conjunction with step 4 of the method described above.

Finally, registers H₀, H₁, H₂, H₃, and H₄ are updated as follows. The output of the second full adder 236 is added to the contents of register H₀ 240, and the output of the first full adder 224 is added to the contents of register H₁ 242. A fourth shifter 238 circularly left shifts the contents of register A 202 by 30 bits, and that result is added to the contents of register H₂ 244. The contents of register B 204 are added to the contents of register H₃ 246, after register B has been shifted by second shifter 220, and the contents of register C 206 are added to the contents of register H₄ 248. This represents the completion of the second round, t(2i+1), of the algorithm.

As the above description indicates, the second round uses at least one carry save adder and one full adder, in one embodiment. In simplified terms, the second round involves adding another word, W₂ᵢ₊₁, of the 80-word input sequence to the output of the first full adder 224 and to modified and unmodified versions of at least some of the registers A, B, C, D, and E. When the second round is implemented in hardware (e.g., in an ASIC), the hardware includes a second logic block, and the second round is performed during a pass through the second logic block.

During one iteration, the critical path includes CSAs 212, 216, 222, first full adder 224, CSA 234, and second full adder 236. Because the critical path for this embodiment includes only two full adders, as opposed to four full adders in the critical path for SHA-1, the logic depth and the amount of time to process a full message is substantially reduced from the SHA-1 implementation.

After all iterations of the algorithm are completed for all of the message blocks, the output of the process (e.g., the message digest) can be input into a verification or signature algorithm (e.g., DSA), or can otherwise be stored, transmitted, or used to compute a value that has some usefulness.

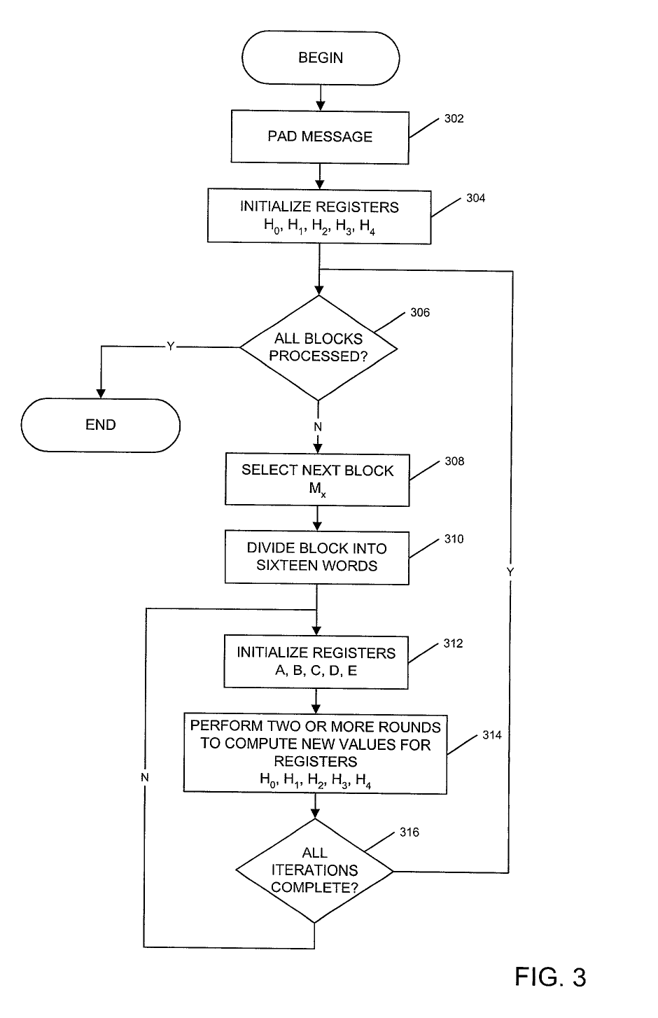

FIG. 3 illustrates a flowchart of a method for creating a message digest, in accordance with one embodiment of the present invention. It would be obvious to one of skill in the art, that the method could be entirely or partially accomplished in an integrated circuit (e.g., an ASIC) and/or by software.

The method begins, in block 302, by padding the message for which a message digest is to be computed, if necessary. As described previously, if a message is not a multiple of 512 bits, then the method first pads the message with a single “1” and as many zeros are necessary to make the message a multiple of 512 bits, except that the last 64 bits of the last 512-bit block are reserved for the length, l, of the original message. The padded message is then processed by the algorithm as n 512-bit blocks, M₁, . . . , Mₙ.

In block 304, registers H₀, H₁, H₂, H₃, and H₄ are initialized. In one embodiment, these registers are initialized to be the same values as the predetermined set of initialization values used in SHA-1. These values are as follows, in hex:

H₀=67452301

H₁=EFCDAB89

H₂=98BADCFE

H₃=10325476

H₄=C3D2E1F0.

In block 306, a determination is made whether all message blocks, M₁, . . . , Mₙ, have been processed. If so, then the method ends. If not, then the next message block, Mₓ, is selected for processing in block 308. During the first iteration of the outside loop that includes blocks 306-316, the “next block” is block M₁. In block 310, the selected message block is then divided into sixteen 32-bit words, L₀, L₁, . . . , L₁₅, where L₀ is the left-most word.

The registers, A, B, C, D, and E are then initialized, in block 312, to the then-current values of the registers H₀, H₁, H₂, H₃, and H₄, respectively. In block 314, two or more rounds are performed during a single iteration to compute new values for registers H₀, H₁, H₂, H₃, and H₄. In one embodiment, these new values are computed using steps 3, 4, and 5 of the operations described in conjunction with FIG. 2. Specifically, these operations involve using the appropriate non-linear functions and values for Wₜ and Kₜ, for the round, and calculating and/or adding values to the prior contents of registers H₀, H₁, H₂, H₃, and H₄. As was described previously, each successive round sequentially operates on the words, Wₜ, of the 80-word input sequence.

In block 316, a determination is made whether all iterations have been completed of the inside loop that includes blocks 312-316. If not, then registers A, B, C, D, and E are again initialized, in block 312, and the method iterates as shown. If all iterations have been completed, then a determination is again made, in block 306, whether all message blocks have been processed, and the method iterates or terminates as shown.

In one embodiment, the number of iterations of the inside loop that includes blocks 312-316 is forty. Accordingly, the number of iterations is reduced to half of the number of iterations necessary using SHA-1. This is possible, in one embodiment, because two rounds, t, are performed during each inside-loop iteration of the algorithm, where only one round is performed during each iteration of SHA-1. Because each iteration through SHA-1 or through this embodiment of the present invention corresponds to one clock cycle, it is apparent that this embodiment of the present invention reduces the number of clock cycles to compute a message digest to half the number of clock cycles necessary for SHA-1 to compute the same message digest.

In other embodiments, more than two rounds are performed during each inside-loop iteration of the algorithm. This is achieved, in various embodiments, by duplicating the logic shown in FIG. 2. In other words, rather than adding the values of TEMP I, TEMP2, S³⁰(A), S³⁰(B), and C to the registers H₀, H₁, H₂, H₃, and H₄, respectively, as described in steps 4 and 5 of the description corresponding to FIG. 2, the logic (and/or software steps) corresponding to steps 2-5 could be duplicated one or more times. Each time the logic is duplicated, the algorithm calculates two additional rounds during each inside-loop iteration. Accordingly, any multiple of two rounds (e.g., 2, 4, 6, . . . , 80) could be calculated in the various embodiments of the invention.

The number of clock cycles to perform each iteration is approximately eighty divided by the number of rounds performed per iteration. Theoretically, all eighty rounds could be calculated in one iteration and during one clock cycle. By increasing the number of rounds performed per iteration, it may be necessary to decrease the clock speed, as the delays between registers may slow down the process. In addition, the additional logic per iteration means that more hardware or more software steps would be necessary per iteration.

The above description indicates that the algorithm operates on input words, specifically 32-bit words. In other embodiments, the algorithm could be adapted to operate on larger or smaller words. In addition, in one embodiment, the algorithm and/or the system within which the algorithm operates could be adapted to receive message bits in a serial manner, rather than a parallel manner. In such an embodiment, a sequence of serial bits could be fed into one or more registers (e.g., registers A, B, C, D, and E, or other registers), and once the register is filled to the register size, the word could be processed as described above. The next set of serial bits would then be loaded into the register, and the process would repeat. Accordingly, in one embodiment, the algorithm could include performing a serial to parallel conversion process, prior to performing a round that operates on the set of serial bits that comprise a word.

In one embodiment, some or all of the algorithm operations are performed within an ASIC, where the operations are performed using logic. In other embodiments, some or all of the algorithm operations are performed using software.

The various embodiments could be used in many different types of devices. For example, they could be used in wired or wireless communication devices (e.g., radios, pagers, cellular or conventional telephones), “smart cards,” PCICM cards, access tokens, routers, switches, and any other device that utilizes a one-way hash algorithm. These examples are provided for purposes of illustration and are not intended to limit the use of the various embodiments in other applications.

The message to be processed could originate at a particular device. For example, the message could be stored within a device, or could be generated in real time by the device (e.g., voice data from the device's user). Alternatively, the message could be received from a remote device. In addition, the message digest calculated using the various embodiments could be stored, used or consumed internally by a device, or it could be transmitted to another device for storage and/or processing.

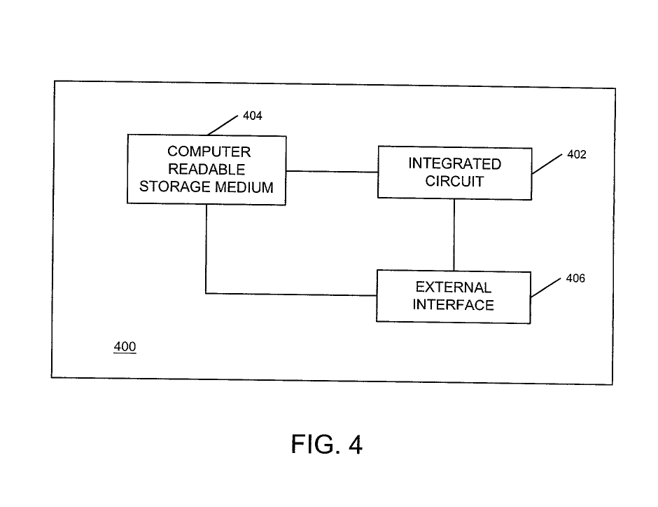

FIG. 4 illustrates an electronic device in which the embodiments of the invention may be practiced, in accordance with one embodiment of the present invention. Device 400 includes integrated circuit 402, computer readable storage medium 404, and external interface 406, in one embodiment.

When all or part of the methods of the various embodiments are implemented in hardware, integrated circuit 402 includes one or more ASICs, each of which include the logic for performing all or part of the one-way hash function. In such an embodiment, device 400 may also include a processor (not shown), which places the input message block in a format that is useable by the ASIC. For example, a processor may be used to pad the message, divide the message into blocks, and/or initialize various registers. Either or both the A, B, C, D, E and/or H₀, H₁, H₂, H₃, H₄ registers could be implemented in integrated circuit 402, a processor, computer readable storage medium 404, or another device.

The message and/or message blocks could be stored in a memory device, such as computer readable storage medium 404, or the message and/or message blocks could be received through external interface 406. Computer readable storage medium 404 could be, for example, RAM, ROM, hard drive, CD, magnetic disk, disk drive, a combination of these types of storage media, and/or other types of storage media that are well known to those of skill in the art. When all or part of the methods of the various embodiments are implemented in software, computer readable storage medium 404 also could be used to store computer executable instructions, which carry out all or part of the methods, when executed. In such an embodiment, integrated circuit 402 could be a microprocessor, ASIC or another type of integrated circuit capable of executing the computer executable instructions. In other embodiments, where storage of computer executable instructions, message data, message digests, or other data is not necessary, device 400 may not include storage medium 404.

External interface 406 could be, for example, a user interface (e.g., a keyboard, speaker, or other input device) or an interface to a wired or wireless external network, system or device. External interface 406 could be used to receive input messages and/or message blocks, and/or could be used to transmit or receive message digests, digital signatures, or verification or other data that was generated using an embodiment of the present invention. Data received and/or transmitted by external interface 406 could be sent to or received from, respectively, either or both integrated circuit 402 and/or storage medium 404. In other embodiments, where transmission or receipt of message data, message digests or other data is not necessary, device 400 may not include external interface 406.

Conclusion

Various embodiments of a one-way hash algorithm have been described. The various embodiments can be used to produce a message digest that is identical to a message digest produced by SHA-1, given the same input message. However, the algorithms of the various embodiments produce the message digest using half or fewer clock cycles and less logic depth than SHA-1.

In the foregoing detailed description, reference is made to the accompanying drawings, which form a part hereof, and in which are shown by way of illustration specific embodiments in which the invention may be practiced. These embodiments are described in sufficient detail to enable those skilled in the art to practice the invention.

It will be appreciated by those of ordinary skill in the art that any arrangement, which is calculated to achieve the same purpose, may be substituted for the specific embodiment shown. In addition, although certain applications of the embodiments have been listed above, the embodiments could be incorporated into any other application that could benefit from the use of a one-way hash algorithm. The various embodiments could also be used, with or without modifications, as compatible, alternative implementations of other hash algorithms. For example, but not by way of limitation, the embodiments could be used as compatible algorithms to future SHA implementations, such as currently proposed SHA-256 and SHA-512 implementations. Therefore, all such applications and alternative implementations are intended to fall within the spirit and scope of the present invention.

This application is intended to cover any adaptations or variations of the present invention. The foregoing detailed description is, therefore, not to be taken in a limiting sense, and it will be readily understood by those skilled in the art that various other changes in the details, materials, and arrangements of the parts and steps, which have been described and illustrated in order to explain the nature of this invention, may be made without departing from the spirit and scope of the invention as expressed in the adjoining claims.

What is claimed is:

1. A method for creating a message digest from a message, wherein a sequence of input words is derived from the message, and the method comprises:
performing a first round during an iteration of the method, wherein the first round is a calculation that operates on a next word of the sequence;
performing a second round during the iteration of the method, wherein the second round is a calculation that operates on another next word of the sequence; and
repeating performing the first round and performing the second round until calculations have been performed that sequentially operate on all remaining words of the sequence.

2. The method as claimed in claim 1, further comprising performing the first round and the second round during a single clock cycle.

3. The method as claimed in claim 1, wherein performing the first round comprises using at least one carry save adder and a first full adder.

4. The method as claimed in claim 3, further comprising:
initializing a first set of registers to a predetermined set of initialization values;
wherein performing the first round includes
adding the next word of the sequence to modified and unmodified versions of at least some of the first set of registers using the at least one carry save adder; and
incorporating, by the first full adder, a first carry produced by the at least one carry save adder.

5. The method as claimed in claim 3, wherein performing the second round comprises using at least one additional carry save adder and a second full adder.

6. The method as claimed in claim 5, wherein performing the second round comprises:
adding, by the at least one additional carry save adder, the another next word of the sequence to a modified version of an output of the first full adder, and to modified and unmodified versions of at least some of the first set of registers; and
incorporating, by the second full adder, a second carry produced by the at least one additional carry save adder.

7. The method as claimed in claim 1, further comprising performing two or more additional rounds during the iteration.

8. The method as claimed in claim 1, further comprising performing a serial to parallel conversion process on a set of bits to create the next word, the another next word, and the all remaining words.

9. The method as claimed in claim 1, wherein the message comprises one or more 512-bit blocks, each of which includes sixteen 32-bit words, and the message digest includes 160 bits.

10. The method as claimed in claim 1, wherein the message digest is identical to another message digest computed by SHA-1, given a same message.

11. A computer readable medium having computer executable instructions stored thereon for performing a method for creating a message digest from a message, wherein a sequence of input words is derived from the message, and the method comprises:
performing a first round during an iteration of the method, wherein the first round is a calculation that operates on a next word of the sequence;
performing a second round during the iteration of the method, wherein the second round is a calculation that operates on another next word of the sequence; and
repeating performing the first round and performing the second round until calculations have been performed that sequentially operate on all remaining words of the sequence.

12. The computer readable medium as claimed in claim 11, wherein the method further comprises performing the first round and the second round during a single clock cycle.

13. The computer readable medium as claimed in claim 11, wherein performing the first round comprises using at least one carry save adder and a first full adder.

14. The computer readable medium as claimed in claim 13, wherein the method further comprises:
initializing a first set of registers to a predetermined set of initialization values;
wherein performing the first round includes
adding the next word of the sequence to modified and unmodified versions of at least some of the first set of registers using the at least one carry save adder; and
incorporating, by the first full adder, a first carry produced by the at least one carry save adder.

15. The computer readable medium as claimed in claim 13, wherein performing the second round comprises using at least one additional carry save adder and a second full adder.

16. The computer readable medium as claimed in claim 15, wherein performing the second round comprises:
adding, by the at least one additional carry save adder, the another next word of the sequence to a modified version of an output of the first full adder, and to modified and unmodified versions of at least some of the first set of registers; and
incorporating, by the second full adder, a second carry produced by the at least one additional carry save adder.

17. The computer readable medium as claimed in claim 11, wherein the method further comprises performing two or more additional rounds during the iteration.

18. The computer readable medium as claimed in claim 11, wherein the input message comprises one or more 512-bit blocks, each of which includes sixteen 32-bit words, and the message digest includes 160 bits.

19. The computer readable medium as claimed in claim 11, wherein the message digest is identical to another message digest computed by SHA-1, given a same input message.

20. An integrated circuit for creating a message digest from a message, wherein a sequence of input words is derived from the message, and the integrated circuit comprises:
a first logic block which performs a first round during a pass through the first logic block, wherein the first round is a calculation that operates on a next word of the sequence; and
a second logic block, coupled to the first logic block, which performs a second round during a pass through the second logic block, wherein the second round is a calculation that operates on another next word of the sequence, and
wherein additional passes through the first logic block and the second logic block are made until calculations have been performed that sequentially operate on all remaining words of the sequence.

21. The integrated circuit as claimed in claim 20, wherein the pass through the first logic block and the pass through the second logic block are performed during a single clock cycle.

22. The integrated circuit as claimed in claim 20, wherein the first logic block includes at least one carry save adder and a first full adder.

23. The integrated circuit as claimed in claim 22, wherein:
a first set of registers is initialized to a predetermined set of initialization values;
the at least one carry save adder adds the next word of the sequence to modified and unmodified versions of at least some of the first set of registers; and
the first full adder incorporates a first carry produced by the at least one carry save adder.

24. The integrated circuit as claimed in claim 23, wherein the second logic block includes at least one additional carry save adder and a second full adder.

25. The integrated circuit as claimed in claim 24, wherein:
the at least one additional carry save adder adds the another next word of the sequence to a modified version of an output of the first full adder, and to modified and unmodified versions of at least some of the first set of registers; and
the second full adder incorporates a second carry produced by the at least one additional carry save adder.

26. The integrated circuit as claimed in claim 20, further comprising two or more additional logic blocks, coupled to the second logic block, each of which performs another round.

27. The integrated circuit as claimed in claim 20, wherein the input message comprises one or more 512-bit blocks, each of which includes sixteen 32-bit words, and the message digest includes 160 bits.

28. The integrated circuit as claimed in claim 20, wherein the message digest is identical to another message digest computed by SHA-1, given a same message.

29. An electronic device comprising:
an integrated circuit, which creates a message digest from a message, wherein a sequence of input words is derived from the message, and the message digest is created by performing a first round during an iteration of a one-way hash algorithm, wherein the first round is a calculation that operates on a next word of the sequence, and by performing a second round during the iteration of the method, wherein the second round is a calculation that operates on another next word of the sequence, and by repeating performing the first round and performing the second round until calculations have been performed that sequentially operate on all remaining words of the sequence.

30. The electronic device as claimed in claim 29, wherein the integrated circuit is a processor, and the electronic device further comprises:
a computer readable medium, coupled to the integrated circuit, which has computer executable instructions stored thereon that cause the processor to perform the first round, perform the second round, and repeat performing the first round and the second round.

31. The electronic device as claimed in claim 29, wherein the integrated circuit comprises:
a first logic block, which performs the first round during a pass through the first logic block; and
a second logic block, coupled to the first logic block, which performs the second round during a pass through the second logic block, and
wherein additional passes through the first logic block and the second logic block are made until calculations have been performed that sequentially operate on all remaining words of the sequence.

32. The electronic device as claimed in claim 29, further comprising:
an external interface, which transmits the message digest.

33. The electronic device as claimed in claim 29, further comprising:
an external interface, which transmits data that was generated from the message digest.
